(19) United States
(12) Patent Application Publication
(10) Pub. No.: US 2014/0222402 A1
(43) Pub. Date: Aug. 7, 2014

(54) Systems and Methods for X-Ray Source Weight Reduction

(71) Applicant: Rapiscan Systems, Inc., Torrance, CA (US)

(72) Inventors: Willem G.J. Langeveld, Menlo Park, CA (US); Edward D. Franco, San Mateo, CA (US)

(73) Assignee: Rapiscan Systems, Inc., Torrance, CA (US)

(21) Appl. No.: 14/174,558

(22) Filed: Feb. 6, 2014

Related U.S. Application Data
(60) Provisional application No. 61/761,690, filed on Feb. 6, 2013.

(51) Int. Cl. G06F 17/50

(52) U.S. Cl. CPC G06F 17/5009
USPC 703/2

(57) ABSTRACT

The present specification discloses an X-ray scanning system having a shield surrounding an X-ray source of an X-ray inspection system, the shield comprising a first material or a combination of the first material and a second material; and a thickness that keeps a radiation dose below a predefined limit at a plurality of locations on a boundary of a defined exclusion zone, wherein the plurality of locations change as the X-ray source moves in a scan direction, and wherein the thickness of the shield varies non-uniformly as a function of a plurality of angles of radiation. In another embodiment, the shield comprises a first inner material and a second outer material; and a thickness and a contour that keeps a radiation dose below a predefined limit at a plurality of locations on a boundary of a defined exclusion zone, wherein the plurality of locations change as the X-ray source moves in a scan direction, and wherein the thickness and contour of the shield varies non-uniformly as a function of a plurality of angles of radiation.

### CROSS-REFERENCE TO RELATED APPLICATIONS

The present application relies on U.S. Provisional Patent Application No. 61/761,690, entitled “Systems and Methods for X-Ray Source Weight Reduction”, and filed on Feb. 6, 2013, which is herein incorporated by reference in its entirety.

The present application relies on U.S. patent application Ser. No. 13/860,458, entitled “Systems and Methods for Using an Intensity Modulated-X-Ray Source” and filed on Apr. 10, 2013, which is a continuation application of U.S. patent application Ser. No. 13/248,079, of the same title, filed on Sep. 29, 2011 and now issued as U.S. Pat. No. 8,437,448, which is a continuation application of U.S. patent application Ser. No. 12/484,172, of the same title, filed on Jun. 12, 2009, and now issued as U.S. Pat. No. 8,054,937, which, in turn, relies on U.S. Provisional Patent Application No. 61/087,810, of the same title and filed on Aug. 11, 2008, all of which are herein incorporated by reference in their entirety.

### FIELD

The present specification relates generally to the field of radiological inspection systems and more specifically to systems and methods of reducing X-ray source shielding requirements, thereby reducing the overall weight of a linear accelerator X-ray source.

### BACKGROUND

X-ray inspection systems include an X-ray generator which typically comprises a heated cathode filament emitting an electron beam. The emitted electrons are accelerated towards a target. The electron beam strikes the target at a focal spot and some portion of the kinetic energy contained in the electron beam is converted into X-ray photons. At the focal spot, the photons are emitted in all directions from the target surface, whereby the intensity and energy of X-rays varies based on the angle with respect to the electron beam direction. The generated X-rays are only allowed to leave a heavily shielded area in a predefined direction.

Current X-ray inspection systems are very heavy, largely due to the massive amounts of shielding required to block the X-rays produced in all directions from the target surface, except for those in the forward direction where the X-rays are used for radiography or other purposes. The aperture in the shielding in the forward direction which allows radiation to exit in the desired directions is known as a collimator. Usually, X-ray sources are employed that are specified to have a fixed fraction of “leakage” of X-ray energy in all directions except the desired direction, and a source is selected with a leakage level that, in combination with setting a certain overall output intensity, will make the source comply with a customer's requirements for a radiation exclusion zone. The radiation exclusion zone is usually defined as a rectangular area, chosen such that the radiation at the boundary of the area does not exceed a certain maximum dose rate, averaged over the course of one hour. Calculations and measurements, however, show that the customer-specified exclusion zone, as well as the actual inspection system geometry, has various asymmetries that lead to an exclusion zone that is better than required in some directions. This may be interpreted to mean that either the exclusion zone could have been smaller in some directions, or that there is too much shielding present in those directions. Since the shielding consists of lead and tungsten, unnecessary extra shielding causes a significant increase in the weight of the X-ray inspection system.

Hence, there is requirement for a system and method to provide an optimized shielding design, thereby reducing the overall weight of an X-ray source employed in an X-ray inspection system such as a mobile cargo inspection system.

### SUMMARY

In one embodiment, the present specification provides an optimized shielding design for reducing the weight of an X-ray source employed in a mobile cargo inspection system.

In another embodiment, the present specification provides an X-ray inspection system employing an optimized shielding design in order to reduce shielding requirements and thereby reduce the overall weight of a linear accelerator X-ray source employed in the inspection system.

An exclusion zone, having a boundary, surrounds said X-ray inspection system wherein said shielding is comprised of a first material and a second material which limits the leakage of emitted radiation.

In another embodiment, the present specification provides a shielding of a non-uniform thickness surrounding an X-ray source in a non-linear outline based on at least radiation angle and position of the X-ray source with respect to an object being scanned.

In another embodiment, the present specification provides an outline of shielding required to surround an X-ray source wherein the shielding is made of lead.

The present specification discloses a method of determining a thickness of shielding surrounding an X-ray source of an X-ray inspection system, said shielding being of a first material or a combination of said first material and a second material, the method comprising the steps of: defining an exclusion zone; calculating a radiation dose at a plurality of locations on a boundary of said exclusion zone, wherein said plurality of locations change as the X-ray source moves in a scan direction; and calculating the thickness of said shield corresponding to each of said plurality of locations such that said thickness keeps said radiation dose below a predefined limit at each of said plurality of locations.

In one embodiment, the first material has a higher density than the second material.

Optionally, in one embodiment, the first material is tungsten and the second material is lead.

In various embodiments, said defining of the exclusion zone depends on at least one of a number of scans performed during a predefined time, a scan speed, a spatial resolution in the scan direction, a source intensity required for a desired imaging penetration of said inspection system and a presence of personnel in a cab of a truck carrying said inspection system.

In various embodiments, the X-ray source is a 4 MV to 9 MV energy source.

Optionally, in one embodiment, the X-ray source is a dual energy source.

The present specification also discloses a method of determining a thickness of a shield surrounding an X-ray source of an X-ray inspection system, said X-ray source having an extended target and said shield being of a first inner material and a second outer material, the method comprising the steps of: defining an exclusion zone; calculating radiation dose at a plurality of locations on a boundary of said exclusion zone, wherein said plurality of locations change as the X-ray source moves in a scan direction; and determining the thickness of said shield corresponding to each of said plurality of locations such that said thickness keeps said radiation dose below a predefined limit at each of said plurality of locations.

In one embodiment, the first inner material has a higher density than the second outer material.

Optionally, in one embodiment, the first inner material is tungsten and the second outer material is lead.

In various embodiments, the defining of the exclusion zone depends on at least one of a number of scans performed during a predefined time, scan speed, spatial resolution in the scan direction, source intensity required for a desired imaging penetration of said inspection system and presence of personnel in a cab of a truck carrying said inspection system.

In various embodiments, the X-ray source is a 4 MV to 9 MV energy source.

Optionally, in one embodiment, the X-ray source is a dual energy source.

The present specification also discloses a shield surrounding an X-ray source of an X-ray inspection system, the shield comprising a first material, wherein said shield has a thickness that keeps a radiation dose below a predefined limit at a plurality of locations on a boundary of a defined exclusion zone, wherein said plurality of locations change as the X-ray source moves in a scan direction, and wherein the thickness of said first material varies non-uniformly as a function of a plurality of angles of radiation.

In one embodiment, the shield further comprises a second material, wherein said first material has a higher density than said second material.

Optionally, in one embodiment, the first material is tungsten and the second material is lead.

In various embodiments, the defining of the exclusion zone depends on at least one of a number of scans performed during a predefined time, scan speed, spatial resolution in the scan direction, source intensity required for a desired imaging penetration of said inspection system and presence of personnel in a cab of a truck carrying said inspection system.

In various embodiments, the source is a 4 MV to 9 MV energy source.

Optionally, in one embodiment, the X-ray source is a dual energy source.

The aforementioned and other embodiments of the present shall be described in greater depth in the drawings and detailed description provided below.

### BRIEF DESCRIPTION OF THE DRAWINGS

These and other features and advantages of the present invention will be appreciated, as they become better understood by reference to the following detailed description when considered in connection with the accompanying drawings:

FIG. 1 illustrates an exemplary inspection layout;

FIG. 2 illustrates a polar plot of the radiation energy as a function of angle of an exemplary X-ray source operating at 4 MV in a plurality of energy bins;

FIG. 3 illustrates a polar plot of the radiation energy as a function of angle of an exemplary X-ray source operating at 6 MV in a plurality of energy bins;

FIG. 4 is a plot of an exclusion zone boundary and locations on the boundary for which radiation dose is calculated in accordance with an embodiment of the present invention;

FIG. 5 illustrates a plot of the distance to the exclusion zone boundary as a function of angle for a plurality of locations of the X-ray source during a scan, in accordance with an embodiment of the present invention;

FIG. 6 illustrates a plot of thickness of shielding required when either lead or a lead/tungsten combination shielding is used, for 4 MV and 6 MV X-ray sources, in accordance with an embodiment of the present invention;

FIG. 7 is a flowchart illustrating a plurality of exemplary steps for determining a variation of thickness of a shield surrounding an X-ray source; and

FIG. 8 illustrates an optimized shielding design, in accordance with an embodiment of the present invention.

### DETAILED DESCRIPTION

The present specification is directed towards an X-ray inspection system employing an optimized shielding design, in order to reduce shielding requirements and thereby reduce the overall weight of a linear accelerator X-ray source employed in the inspection system. Shielding requirements at a plurality of radiation angles are determined and a shielding design is created based on the determined requirements. Hence, the system described in the present specification eliminates the need for a uniform shielding provided in a rectangular area defining an exclusion zone around the X-ray source, thereby reducing the shielding provided and hence reducing an overall weight of the X-ray source.

In an embodiment, the present specification discloses that the weight of, for example, a standard ultra-low (i.e. 10⁻⁶ leakage fraction) X-ray source of approximately 7800 lbs is reduced by several thousand pounds by using an optimized shielding design.

In one embodiment, the present specification discloses a shielding design allowing for a significant weight reduction and performance improvement in an X-ray inspection system. In one embodiment, the methods of the present invention are used in mobile cargo inspection systems. In other embodiments, methods are used in any radiological application, where reduced shielding and overall weight is desired.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Conventionally, for mobile cargo inspection systems, an exclusion zone is defined as a rectangular area surrounding a cargo container to be inspected, for which the radiation dose, averaged over one hour, does not exceed a required dose rate at one meter height at any given location on the rectangular boundary. Factors affecting the exclusion zone definition comprise, but are not limited to: number of scans performed during a predefined time, scan speed, spatial resolution in the scan direction, and source intensity required for a given desired imaging penetration of the inspection system.

Radiation reaching the rectangular boundary is typically composed of a first part and a second part. The first part is caused by radiation transmitted directly from the X-ray source through the shielding. The second part is caused by radiation exiting through a collimator in the desired direction, which is scattered, to an extent, in all directions after striking an object being scanned, or the detector array behind the object, or a beam stop behind the detector array. In actual practice, the total amount of radiation at the boundary is limited by rules established by a customer. As an example, for the US Customs and Border Protection Agency, the required dose rate limit is about 50 μR/hr. However, persons of ordinary skill in the art would appreciate that the required dose rate may vary in alternate embodiments. Thus, a sum of the first and second parts of the radiation must stay below the given/prescribed limit. To allow for varying objects to be scanned, it is prudent to limit the contribution of the first part of the radiation to only a fraction of that of the second part. As an example, the dose limit due to radiation transmitted directly from the source through the shielding may be limited to a maximum of 12.5 μR/hr at the boundary of the exclusion zone.

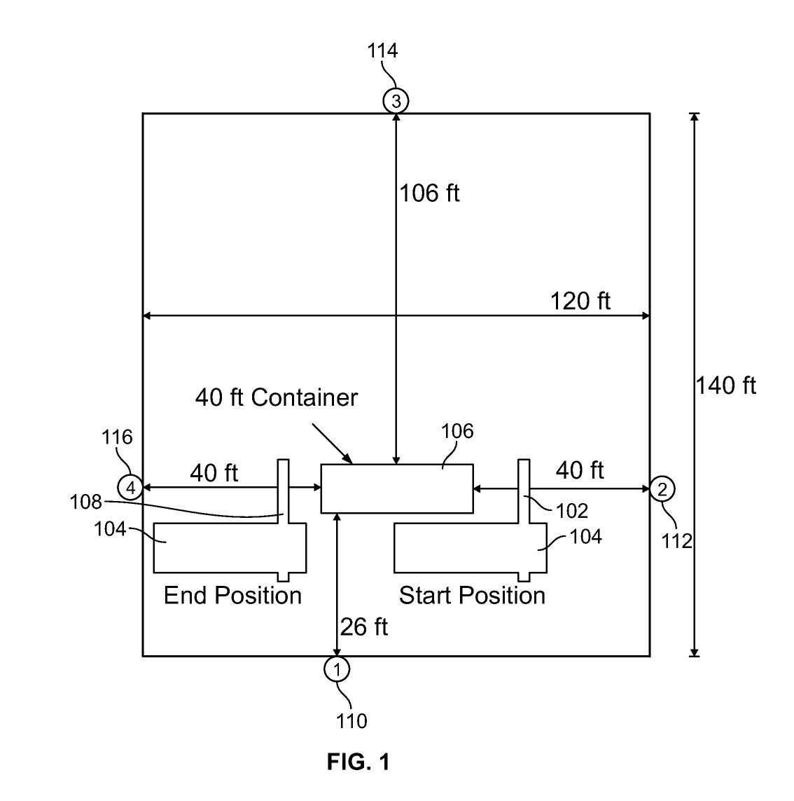

Typically, during a scan, the mobile inspection system is driven from a start position just before the beginning of a cargo container being inspected, along the container, and finally to a finish position just after the end of the container, but within a predefined exclusion zone. As an example, FIG. 1 illustrates the inspection layout used by an exemplary regulatory agency, such as in the Factory Acceptance Test (FAT) for the Department of Homeland Security (DHS) Customs and Border Protection (CBP) agency. As illustrated, a start position 102 of a mobile inspection system 104 is, for example, 5 feet before the beginning of a cargo container 106 being inspected and the finish position 108 is, for example, 5 feet after the end of the container 106.

The performance of a mobile inspection system 104 during a FAT is determined by calculating an average dose per hour at four different boundary locations. The four scan locations are illustrated in FIG. 1 as first location 110, second location 112, third location 114 and fourth location 116. After obtaining such information, the locations are analyzed to determine which, if any, has an acceptable or unacceptable performance, where performance is measured by the number of scans that can be obtained per hour, with reference to a predetermined number, such 10 or 20 scans, before a radiation dose limit such as 50 μR/hr, is reached or exceeded. Often, the main cause of low performance (a number of scans per hour below the predetermined number before the radiation does limit is reached) is caused because a scan location is positioned directly in line with the primary beam of the mobile inspection system. In such cases where acceptable performance is measured at a scan location (a number of scans per hour at or above the predetermined number before the radiation dose limit is reached), X-ray source shielding in the direction of these locations within the exclusion zone may be rationalized, optimized, reduced or decreased for obtaining an overall reduction in the weight of the X-ray source.

In an embodiment of the present invention, calculations are performed to optimize or rationalize the weight of shielding, which is the main contributor to the weight of the X-ray source in an X-ray inspection system, using X-ray yield and the angular distribution of X-rays emitted by an X-ray source.

It is described throughout the present specification that the radiation dosage at 36 radiation points is measured on an exclusion zone boundary, starting at a reference point of a line 5 degrees from the X-ray source in the forward direction, and increasing the angle by 10 degrees at each point, forming the angle of separation. In this case, the same angle of separation is used between each point. It should be understood that any number of points may be employed in the methods of the present specification. It is preferred that at least 12 points are employed, where the angle of separation is at least 30 degrees, however, fewer than 12 points may be measured and used by interpolation. In addition, greater than 36 points may be used, especially in cases where the radiation is more intense; however, since radiation varies predictably with the direction in which it is emitted and does not exhibit dramatic peaks at any angle, it is not necessary that greater than 36 points are employed.

The radiation measurements associated with specific angles relative to the normal line can be correlated with shielding thickness. In general, for a given shielding material, the radiation intensity, I, for radiation having an energy, E, changes in accordance with the following Equation:

I=I₀e^{-{μ}^{ₑₙ}^{/ρ}(E)ρt} Equation 1

where I₀ is the unattenuated intensity; {μₑₙ/ρ}(E) is material-specific mass attenuation coefficient for the specific material used for shielding, which in turn is a function of the radiation energy, E, and which is tabulated, for example by NIST for many materials; ρ is the density of the material; and t is the thickness of the material.

Since the radiation produced by an X-ray source has a spectrum comprising many energies, the total intensity change due to shielding must be calculated using an integral over all of the energies in the spectrum, weighted by the prevalence of each energy in that spectrum. Further, it has to be taken into account that the intensity measured at the boundary scales with the inverse square of the distance to that boundary in the particular direction under consideration. Finally, it must be taken into consideration that during the scan, the system and its X-ray source moves, and therefore, these distances change as well.

It should be noted that generally, the radiation intensity behind a shielding material changes by a factor of roughly two (at energies between 4 and 9 MeV) for each 1 inch of steel shielding, or each 0.52 inches of lead shielding or each 0.34 inches of tungsten shielding. The difference between lead and tungsten is primarily because of the different densities (11.4 g/cc for lead and approximately 18 g/cc for a 95% tungsten alloy). Thus, the correlation between the change in radiation intensity is not in a 1:1 ratio—if the radiation intensity changes by 10%, then the thickness of the shielding does not necessarily vary by 10%.

To illustrate a method of optimizing or rationalizing the weight of an X-ray source shielding, the X-ray yield and angular distribution of the X-rays emitted by an exemplary X-ray source have been calculated at 4 MV and at 6 MV operations, by using an EGS particle transport code. EGS is a Monte Carlo code for performing simulations of the transport of electrons and photons in arbitrary geometries. It should be appreciated that in various embodiments, the X-ray source energy may vary from 4 MV to 9 MV. In still further embodiments, the X-ray source is a dual-energy source.

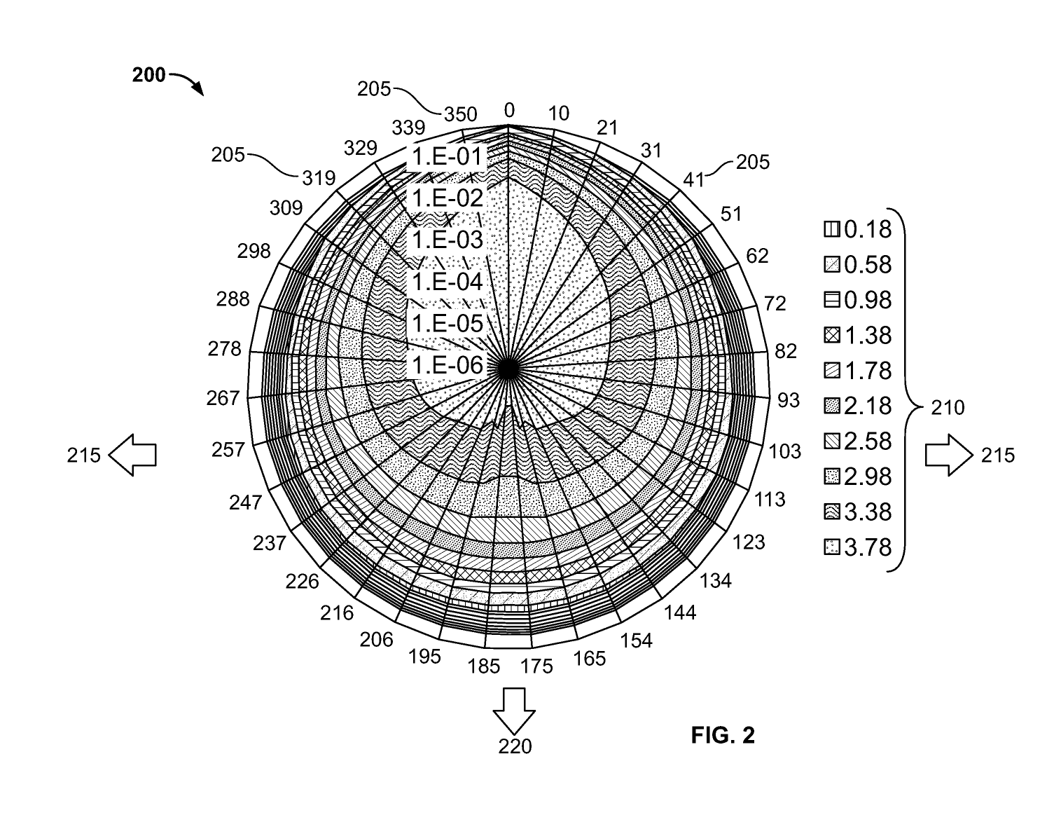

FIG. 2 illustrates a polar plot 200 of the radiation energy as a function of radiation angles 205 of an exemplary X-ray source operating at 4 MV in a plurality of energy bins 210. A radiation angle is defined as follows: a reference line is defined by extending the line formed by the electron beam that produces the X-rays, forward from the target, and, if necessary, projecting it onto the horizontal plane through the target. A second line is formed in the same horizontal plane, said line also passing through the target. The radiation angle is defined as the angle between the reference line and the second line. By starting at a radiation angle of 5 degrees and changing the angle by 10 degrees each time, 36 radiation angles 205 are plotted for 360 degree coverage. As is illustrated in plot 200 of FIG. 2, the 4 MV source has a greater amount of radiation emitted off to the side direction 215 and in the backward direction 220 with reference to the forward direction of the X-ray source.

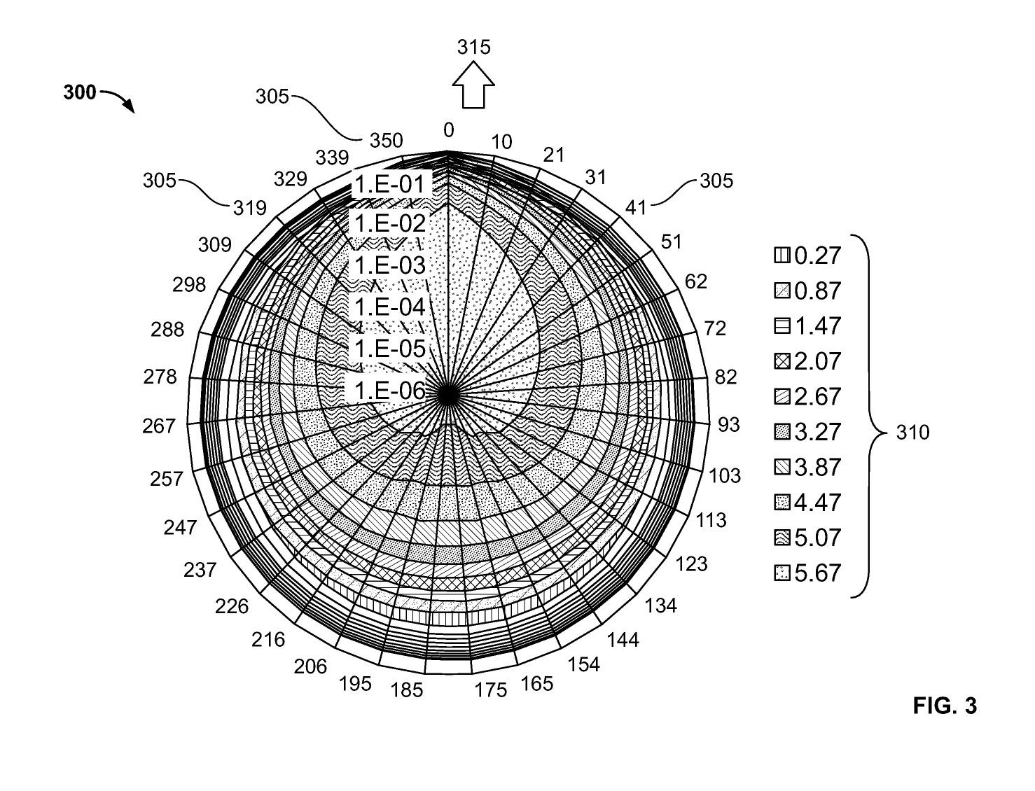

FIG. 3 illustrates a polar plot 300 of the radiation energy as a function of radiation angles 305 of an exemplary X-ray source operating at 6 MV in a plurality of energy bins 310. The radiation angle is defined as previously stated. As is illustrated in plot 300 of FIG. 3, the 6 MV source has, relatively, a greater amount of radiation emitted in forward direction 315, than the 4 MV source. Hence, a higher-energy source is easier to shield than a lower-energy source, given the same forward intensity.

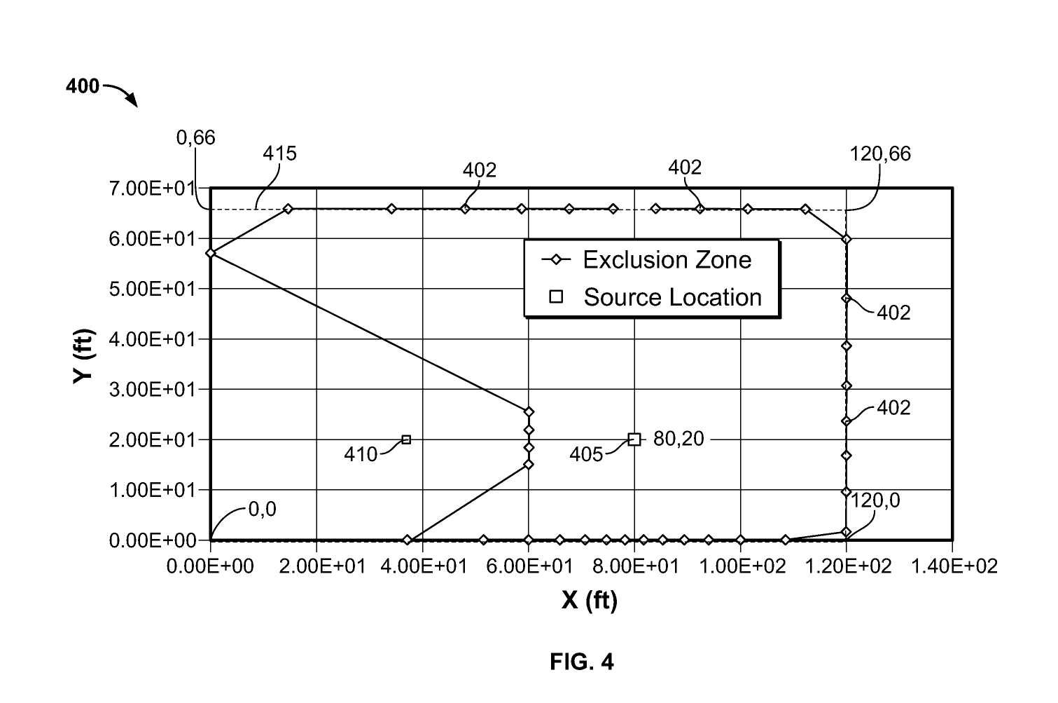

In one embodiment of the present invention, using the principles modeled above, the contribution of X-rays to the dose at an exclusion zone boundary of a mobile cargo inspection system is calculated in a plurality of directions. FIG. 4 is a plot 400 of exclusion zone boundary locations 402 for which the dose was calculated, for an example where the X-ray source, located at position 405 which is 85 feet in the x-direction and 20 feet in the y-direction, is driven from a start position of 5 feet before the beginning of a cargo being inspected (which in this example is 40 feet long) along the container in the negative x direction to a finish position of 5 feet after the end of the cargo. At the finish position 410, the source is located at 35 ft in the x-direction and 20 ft in the y-direction. The dose produced by radiation transmitted through the shielding is now calculated at various locations 402 on an exclusion zone boundary. Boundary locations 402 are chosen as the intersection of a line with a starting point at the target of the source and ending at various locations along the boundary, where the line makes an angle with respect to the forward X-ray direction. By starting at a 5 degree angle and changing the angle by 10 degrees each time, 36 boundary locations 402 are chosen for 360 degree coverage.

It is observed that the radiation produced by the source, and attenuated by the shielding surrounding the source, drops with the inverse square of the distance of the source to the location on the boundary. During a scan, the inspection system moves in the scan direction, and the exclusion zone boundary locations 402 change as well. The plot 400 of FIG. 4 illustrates the exclusion zone boundary locations 402 plotted for the case the X-ray source is located 80 feet in the x direction and at 20 feet in the y direction, near the start of the container.

Persons of ordinary skill in the art should appreciate that the resulting boundary locations 402 are determined, in part, by the exclusion zone required by a customer. In this example, the exclusion zone 415 is 120 feet wide in the x direction and 66 feet wide in the y direction. As shown, the boundary 415 starts at the origin (0, 0) in x and y, extends along the positive x axis for 120 feet to (120, 0), then from there in the positive y direction for 66 feet to (120, 66), and then back in the negative x direction for 120 feet (0, 66) and then back to the origin at (0, 0). The selection of various boundary locations 402 also takes into consideration that the driver of a truck carrying the mobile X-ray inspection system, and its operators, may be inside the cab of the truck and/or inside the operator housing, if present, about 20 feet in front of the X-ray source location.

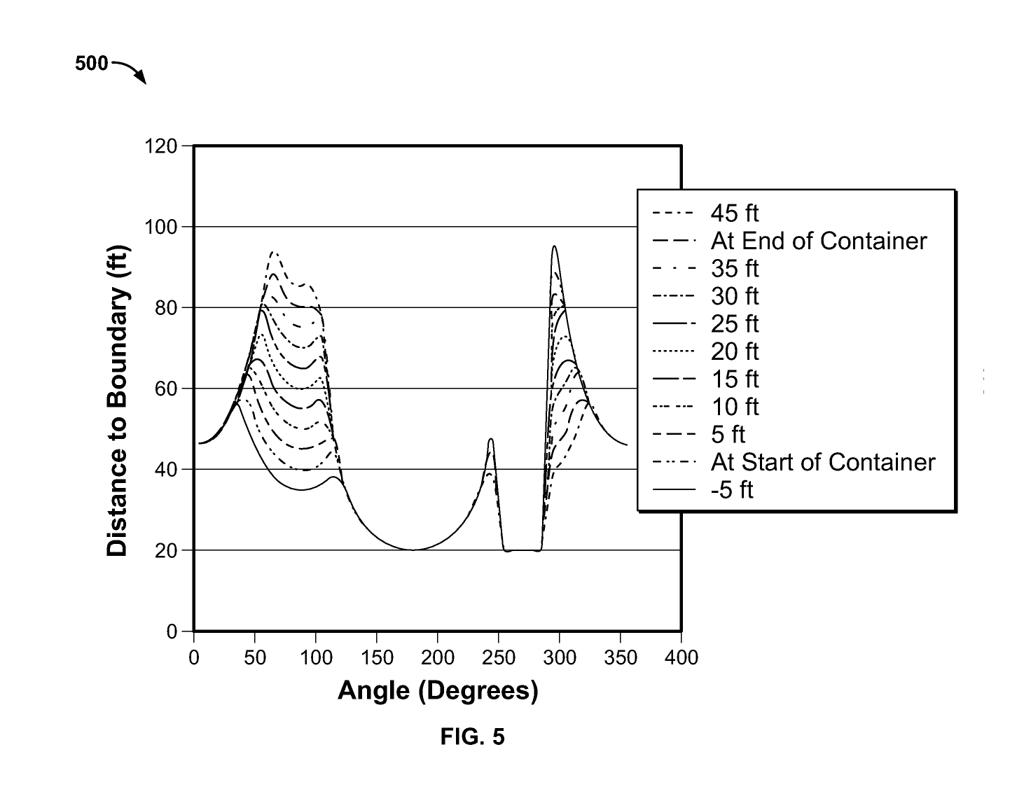

FIG. 5 illustrates a plot of the distance to the exclusion zone boundary as a function of angle for a plurality, and in this case, thirteen locations of the X-ray source during a scan. As shown, graph 500 plots the distance between the X-ray source and the exclusion zone boundary for thirteen locations during the scan, spaced by 5 feet along the scan direction.

FIGS. 4 and 5 demonstrate that the exclusion zone boundaries surrounding an item being scanned by a moving X-ray source change with a change in radiation angle and position of the source. Hence, instead of providing a uniform shielding around the X-ray source an optimized or rationalized shielding design is provided by the present specification.

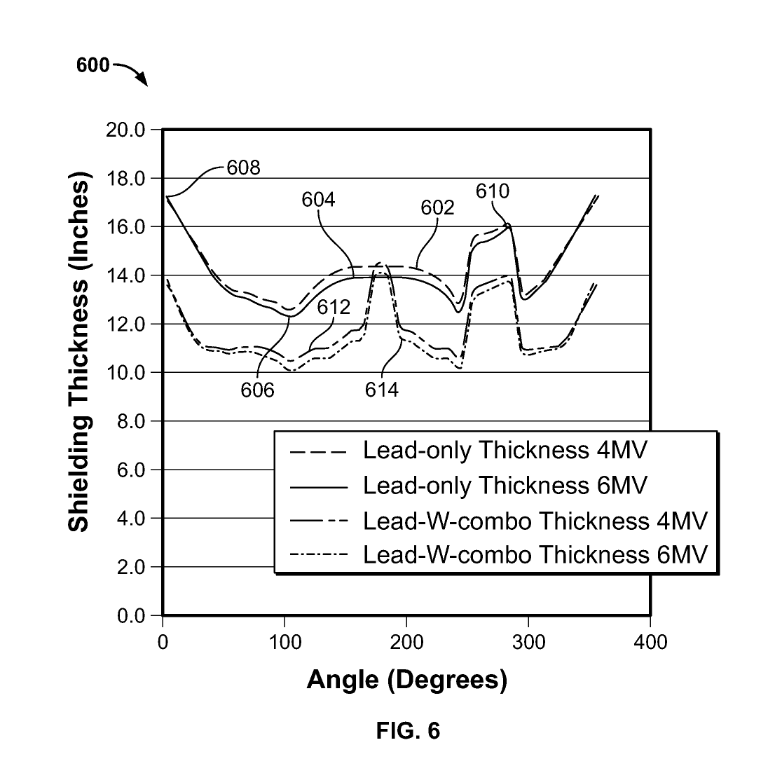

FIG. 6 illustrates a plot 600 of thickness of shielding required when either lead or a lead/tungsten combination shielding is used, for 4 MV and 6 MV X-ray sources.

In order to obtain graph 600, it has been assumed that the X-ray source is operated essentially full time at a dose rate of 10 R/min at a distance of 1 m in front of the source. Also, the radiation leakage has been assumed to contribute no more than 25% of the desired dose limit of 50 μR/hr at each location averaged over the thirteen source locations, as shown in FIG. 5. NIST μₑₙ/ρ tables are used in performing the calculations (that correlate dosage rate with amount of shielding required) for obtaining graph 600.

Therefore, graph 600 shows the thickness of shielding as a function of radiation angle which would be required to accomplish the goal of limiting shielding leakage to 12.5 μR/hr on the exclusion zone boundary of a mobile inspection system. Plotline 602 represents a thickness of shielding required when lead shielding is used, for a 4 MV X-ray source; and plotline 604 represents a thickness of shielding required when lead shielding is used, for a 6 MV X-ray source. When only lead is used, the required amount of shielding ranges from about 12.3 inches, shown as 606, for the 6 MV source at about 100 degrees, to 17.3 inches, shown as 608, at 0 (or 360) degrees, i.e. the forward direction directly outside a fan beam collimator. The peak 610 near 270 degrees illustrates the need for extra shielding at the location due to proximity of the operator cab.

The lead on the outside of the shielding contributes most to the weight of an X-ray source. In an embodiment, a small tungsten shield is used inside the lead shield. This reduces the requirement of lead and thereby the weight of the X-ray source. In an embodiment, a tungsten cylinder having a 7 inches diameter and 10 inches length is used as the inner shield, with the X-ray source spot at 6 inches from the front side. Plot 612 represents the thickness of shielding required when lead and tungsten combination shielding is used, for a 4 MV X-ray source; and Curve 614 represents the thickness of shielding required when lead and tungsten combination shielding is used, for a 6 MV X-ray source. As illustrated, the total shielding thickness required is reduced by using a lead and tungsten combination shielding to values represented by the green and teal curves in FIG. 6.

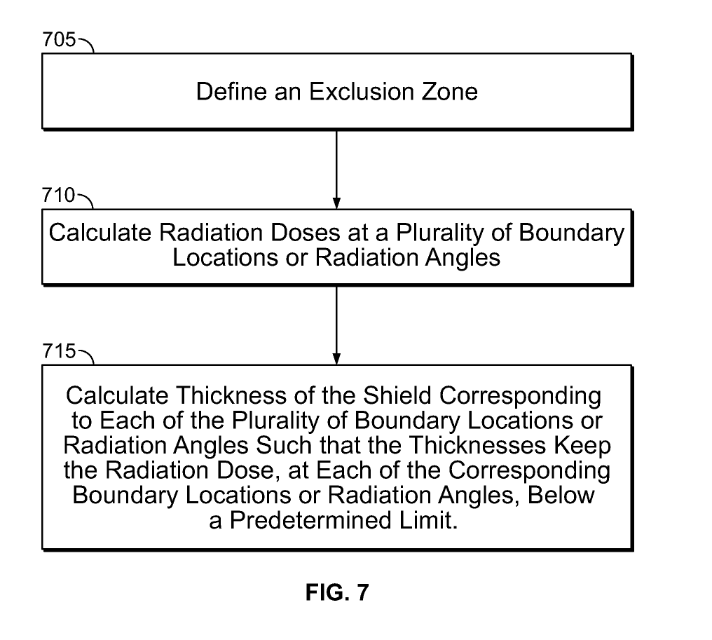

FIG. 7 is a flowchart illustrating a plurality of steps for determining a variation of thickness of a shield surrounding an X-ray source. At step 705, an exclusion zone is defined in accordance with a client's specifications such as, but not limited to, number of scans performed during a predefined time, scan speed, spatial resolution in the scan direction, source intensity required for a desired imaging penetration of an inspection system and presence of personnel in a cab of a truck carrying the inspection system. Then, at step 710, radiation doses are calculated at a plurality of boundary locations or radiation angles, say ‘n’, of the exclusion zone.

The plurality of boundary locations or radiation angles are chosen, in one embodiment, as the intersection of a line with a starting point at the center of the target of the source and ending at various locations along the boundary, where the line makes an angle with respect to the forward X-ray direction.

By starting at a 5 degree angle and changing the angle by 10 degrees each time, 36 boundary locations or radiation angles are chosen for 360 degree coverage. Therefore, ‘n’ is 36 in accordance with one embodiment of the present specification.

Thereafter, at step 715 thicknesses of the shield are calculated corresponding to each of the plurality of boundary locations or radiation angles such that the thicknesses keep the radiation dose, at each of the corresponding boundary locations or radiation angles, below a predetermined limit. In one embodiment, the shield is formed of lead while in an alternate embodiment the shield is formed of an inner tungsten layer combined with a lead outer layer. In one embodiment the thickness of the shield varies non-uniformly as a function of a plurality of angles of radiation or boundary locations.

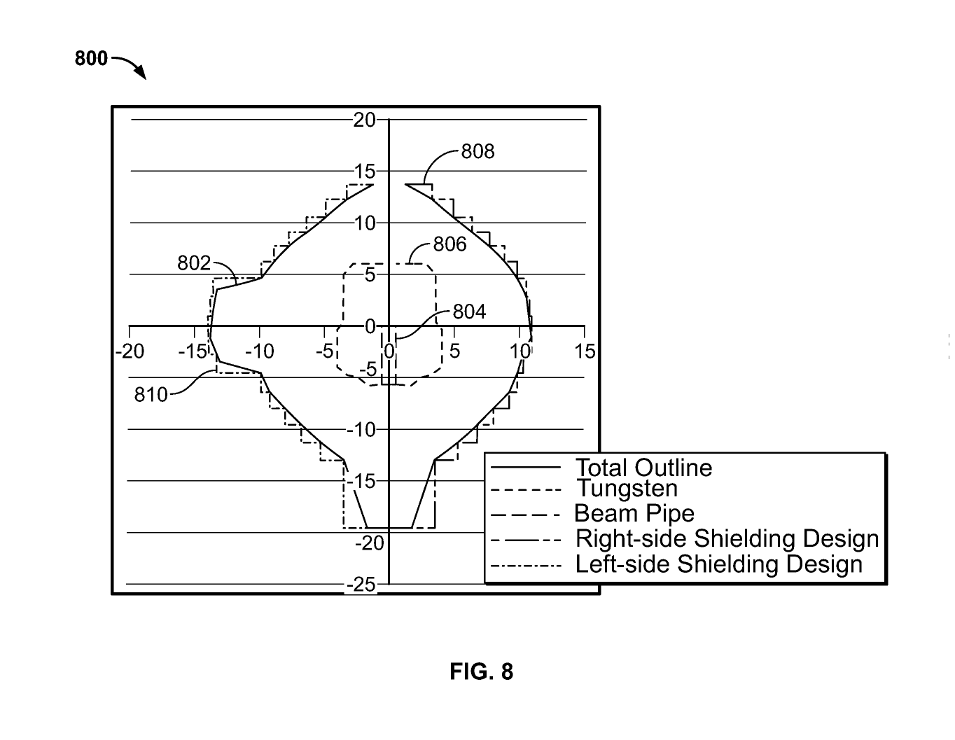

In another embodiment of the present invention, a shielding design is calculated by taking into consideration an extended target, such as a beam pipe, having a length of 6 inches and a diameter of 1 inch, associated with the X-ray source. FIG. 8 illustrates an optimized shielding design, in accordance with an embodiment of the present invention. Plotline 802 in plot 800 represents a total shielding outline provided by the present specification. Plotline 804 represents the extended target, curve 806 represents the outline of a tungsten shield. Stepped lines 808, 810 represent practical implementations of the right-hand and left-hand total shielding designs with respect to an X-ray source when tungsten and lead shielding is employed. In an embodiment, with reference to FIG. 8, a total calculated weight of the tungsten inner shield is roughly 150 kg (330 lbs). The total calculated weight of lead as per FIG. 8 is then 1215 kg (2673 lbs) for a 6 MV source, and 1310 kg (2882 lbs) for a 4 MV source. Assuming a weight of about 150 lbs for a linear accelerator associated with the X-ray source being shielded, 150 lbs for a RF source, and 500 lbs for the enclosure, a total weight of the X-ray source may be reduced to about 4000 lbs for a 4 MV source and about 3800 lbs for a 6 MV source. The calculated weight for a 6 MV source of 4000 lbs compares favorably with that of the weight of a standard 6 MV source, which, for the ultra-low-leakage (10⁻⁶ leakage fraction) version, is about 7800 lbs. Hence, the present invention provides an optimized shielding design which causes a significant weight reduction in an overall weight of an X-ray source employed in a mobile cargo inspection system.

In another embodiment of the present invention, a shielding design is further calculated by taking into consideration that radiation emitted in the downward direction is partially shielded by the presence of the ground, such as a road or an expanse of concrete. Shielding in that direction can be reduced, depending on various geometrical considerations.

In another embodiment of the present invention, a shielding design is further calculated by taking into consideration that radiation emitted in the upward direction is unlikely to cause personal harm to personnel at the exclusion zone boundary, even if scattered by the air. In such cases, where personnel are not present at high elevations near the scanning location, shielding in the vertical direction may also be reduced.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A method of determining a thickness of shielding surrounding an X-ray source of an X-ray inspection system, said shielding being of a first material or a combination of said first material and a second material, the method comprising the steps of:
defining an exclusion zone;
calculating a radiation dose at a plurality of locations on a boundary of said exclusion zone, wherein said plurality of locations change as the X-ray source moves in a scan direction; and
calculating the thickness of said shield corresponding to each of said plurality of locations such that said thickness keeps said radiation dose below a predefined limit at each of said plurality of locations.

2. The method of claim 1, wherein said first material has a higher density than said second material.

3. The method of claim 1, wherein said first material is tungsten and said second material is lead.

4. The method of claim 1, wherein said defining of the exclusion zone depends on at least one of a number of scans performed during a predefined time, a scan speed, a spatial resolution in the scan direction, a source intensity required for a desired imaging penetration of said inspection system and a presence of personnel in a cab of a truck carrying said inspection system.

5. The method of claim 1, wherein said X-ray source is a 4 MV to 9 MV energy source.

6. The method of claim 1, wherein said X-ray source is a dual energy source.

7. A method of determining a thickness of a shield surrounding an X-ray source of an X-ray inspection system, said X-ray source having an extended target and said shield being of a first inner material and a second outer material, the method comprising the steps of:
defining an exclusion zone;
calculating radiation dose at a plurality of locations on a boundary of said exclusion zone, wherein said plurality of locations change as the X-ray source moves in a scan direction; and
determining the thickness of said shield corresponding to each of said plurality of locations such that said thickness keeps said radiation dose below a predefined limit at each of said plurality of locations.

8. The method of claim 7, wherein said first inner material has a higher density than said second outer material.

9. The method of claim 7, wherein said first inner material is tungsten and said second outer material is lead.

10. The method of claim 7, wherein said defining of the exclusion zone depends on at least one of a number of scans performed during a predefined time, scan speed, spatial resolution in the scan direction, source intensity required for a desired imaging penetration of said inspection system and presence of personnel in a cab of a truck carrying said inspection system.

11. The method of claim 7, wherein said X-ray source is a 4 MV to 9 MV energy source.

12. The method of claim 7, wherein said X-ray source is a dual energy source.

13. A shield surrounding an X-ray source of an X-ray inspection system, the shield comprising a first material, wherein said shield has a thickness that keeps a radiation dose below a predefined limit at a plurality of locations on a boundary of a defined exclusion zone, wherein said plurality of locations change as the X-ray source moves in a scan direction, and wherein the thickness of said first material varies non-uniformly as a function of a plurality of angles of radiation.

14. The shield of claim 13 further comprising a second material, wherein said first material has a higher density than said second material.

15. The shield of claim 14, wherein said first material is tungsten and said second material is lead.

16. The shield of claim 13, wherein said defining of the exclusion zone depends at least on: number of scans performed during a predefined time, scan speed, spatial resolution in the scan direction, source intensity required for a desired imaging penetration of said inspection system and presence of personnel in a cab of a truck carrying said inspection system.

17. The shield of claim 13, wherein said X-ray source is a 4 MV to 9 MV energy source.

18. The shield of claim 13, wherein said X-ray source is a dual energy source.
